(19) United States
(12) Patent Application Publication
(10) Pub. No.: US 2007/0008729 A1
(43) Pub. Date: Jan. 11, 2007

(54) FLUORESCENT LIGHT SHADE

(76) Inventor: James L. Tarpo, Aliso Viejo, CA (US)

Correspondence Address: LAW OFFICES OF LARRY K. ROBERTS, INC., 2 Park Plaza, Suite 300, Irvine, CA, 92614, US

(21) Appl. No.: 11/427,021

(22) Filed: Jun. 28, 2006

Related U.S. Application Data
(60) Provisional application No. 60/697,846, filed on Jul. 8, 2005.

(51) Int. Cl. F21V 11/00

(52) U.S. Cl. 362/351

(57) ABSTRACT

A space may be illuminated by installing a shade structure in a light fixture, such that the shade structure is placed on a fixture lens between the lens and a light source of the light fixture. The shade structure includes a thin translucent layer including an artwork pattern or image formed thereon or embedded therein. Light emitted by the light source passes through the shade structure and the artwork, then through the fixture lens and into the space, producing a lighting effect different from that produced by the light fixture in the absence of the shade.

This application claims priority from provisional application 60/697,846, filed Jul. 8, 2005.

### BACKGROUND

Interior designers and architects worldwide have gone to great lengths to implement attractive decor in commercial office space. Creative designs for windows, shades and draperies are commonplace. Facilities with a more upscale appearance are likely to contain framed artwork on the walls, custom painting, wallpaper, mirroring, custom shelving, and countless other effects. The ceiling lighting however, usually does not include anything unique in the way of custom decor. The lighting provided by the builder is most often of the generic fluorescent type. While providing uniform lighting throughout the facility, these fluorescents do not produce any desirable decorative affects in the way that chandeliers, wall sconces, or perhaps recessed lighting would.

### BRIEF DESCRIPTION OF THE DRAWINGS

FIG. 1 illustrates an exemplary embodiment of a fluorescent light shade as a separate insert partially installed in a slightly opened troffer.

FIG. 2 shows the exemplary shade of FIG. 1 fully installed in the troffer as viewed by an observer standing on the floor below it.

FIG. 3 illustrates an exemplary embodiment of a fluorescent light shade rolled up for transport or storage.

FIG. 4A is a side view depiction of an exemplary embodiment of a fluorescent light shade.

FIG. 4B is a bottom view depiction of the fluorescent light shade of FIG. 4A.

FIG. 5 is an end view of a suspended troffer with an installed fluorescent light shade.

### DETAILED DESCRIPTION

In the following detailed description and in the several figures of the drawing, like elements are identified with like reference numerals. The figures are not to scale, and relative feature sizes may be exaggerated for illustrative purposes.

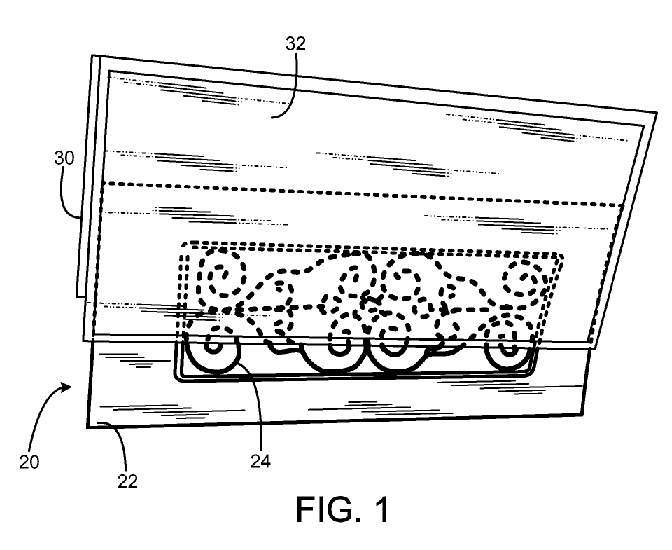

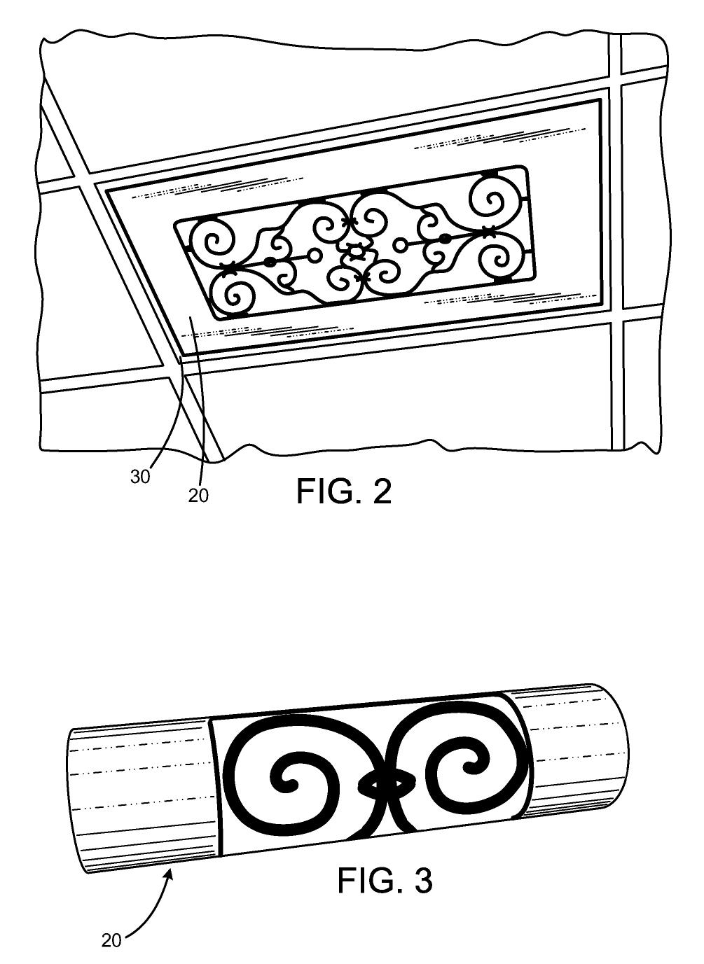

An exemplary embodiment of a fluorescent light shade 20 is depicted in FIGS. 1-3, and includes a decorative sheet 22 of translucent material adapted to be inserted into fluorescent lighting fixtures such as fixture 30. The sheet may have a decorative pattern, design or image 24 applied to, or embedded within, the sheet. When installed in the light fixture 30 such that it is illuminated by light generated by the light fixture, the decorative sheet may produce enhanced lighting effects. This embodiment is not a modification of any of the existing components of a fluorescent light fixture, but an insert that is placed between the fluorescent source and the fixture lens 32. The term “fluorescent shade” or “fluorescent light shade” may sometimes be used to describe the decorative sheet.

An exemplary embodiment of a fluorescent shade employs artwork or decorative image applied to a thin translucent sheet or roll of a backlit medium.

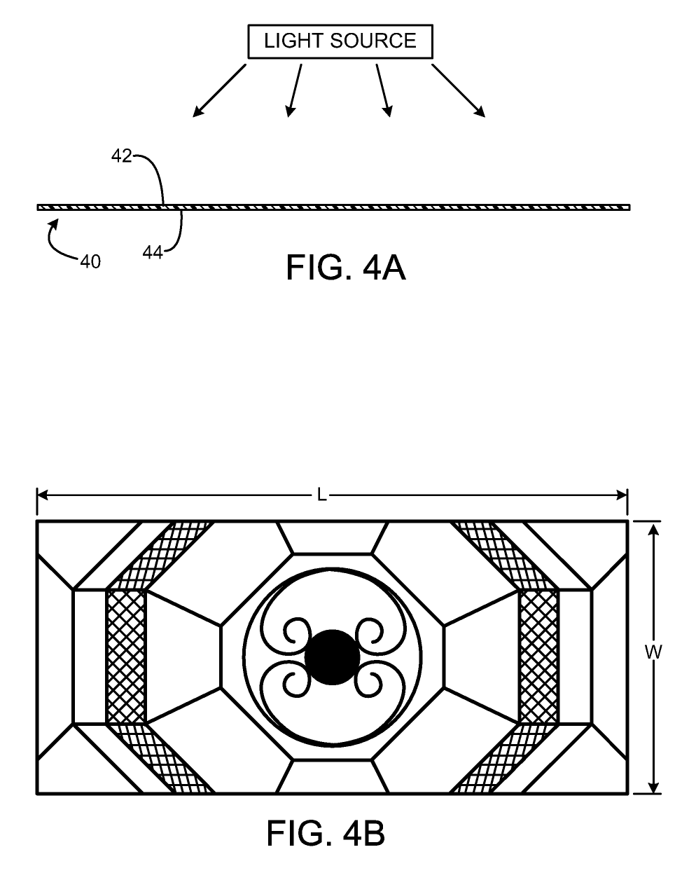

Another embodiment of a fluorescent shade may be fabricated by digital or other imaging applied to Kodak DURATRANS™ or ENDURA™, a translucent material suitable for producing large color transparencies for backlit displays. This embodiment may provide a fluorescent shade containing a near photographic quality image, on a material providing lasting color integrity. FIG. 4 illustrates this embodiment of a fluorescent shade 40. In this example, the shade may have a thickness of 8 mils, a length of 46¼ inch, and a width of 22⅛ inches. For this example, the shade 40 has a surface 42 which when installed in the fixture faces the light source, and a surface 44 which when installed in the fixture faces the viewer. The image may be formed on the surface 42, or the surface 44, or both, or embedded within the layer of translucent material. It may be advantageous for some applications to place the image side down against the troffer lens.

Another embodiment of a fluorescent light shade may include a four or six color screen print on a suitable polyester-based backlit medium, e.g. a 5 mil thick layer of a backlit medium.. This embodiment provides slightly less resolution and image quality, but lower cost and high volume production capability. Since the image may be viewed at a distance of several feet through a fluorescent diffuser lens, in one type of installation this lower cost implementation provides a viable alternative in many cases. Other embodiments may utilize single tone images.

A further embodiment of a fluorescent light shade may be fabricated using large format ink-jet printing techniques on a translucent sheet material such as HP Color Lucent Backlit UV film. This embodiment may provide shorter delivery times and lower cost on small quantities of production relative to screen printing, for example.

An embodiment is directed to a method of converting fluorescent light into a more appealing custom lighting. Consider the prevalence of fluorescent lighting troffers that line ceiling space throughout the world. Many installation sites for the fluorescent light shade have already been prepared. Builders have placed millions of standard-sized, fluorescent light fixtures (many with easily accessible lens or with flip-open lids) in strategic places all over the world, that can be customized to suit the personalities, ambiance preferences, or even advertising needs of the user.

An exemplary implementation of a fluorescent light shade embodiment involves installation in a standard three, or four-bulb, widely available fluorescent troffer employed in suspended ceilings as illustrated in FIGS. 1, 3, and 5. These fixtures are typically similar in size among troffer manufacturers, e.g. approximately 46 inches by 22 inches. An exemplary embodiment of a fluorescent shade may be sized to fit these standard sized troffers. FIG. 1 illustrates the shade 20 as a separate insert structure partially installed in a slightly opened troffer structure 30. FIG. 3 shows the shade 20 fully installed in the troffer 30 as viewed by an observer standing on the floor below it.

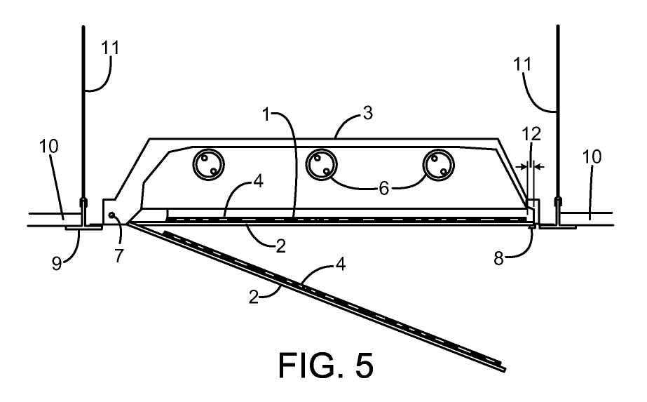

FIG. 5 shows the position of an exemplary shade 1 as installed in a an exemplary embodiment of a troffer 3 mounted in a ceiling with ceiling tiles 10 suspended by suspension wires or bars 11. The troffer 3 is mounted in brackets 9 connected to the brackets 9. Because the troffer lens 2 is positioned below the shade 1 in the lid frame 4, additional structural support and/or adhesives may not be required for a suitable installation. In an exemplary embodiment, the shade 1 may be placed on the upper surface of the lens 2 without use of adhesives. In some cases, slight trimming of the shade may be performed during installation to obtain the clearance 12 between the edge of the shade 1 and the lid frame 4. Typically a clearance value of 0.125 to 0.25 inches may be suitable for this clearance, although this will depend on the particular installation. Because the troffer 3 have a hinge 7 and latch 8 lid assembly, installation is easily achieved by opening the lid, and sliding the shade 1 along the lens 2 into an installed position. With the lid in the open position, the shade is well secured by the frame of the lid. The lid may then be closed, and the installation is completed. With the fluorescent light bulbs 6 energized, the fluorescent light resulting from the energization passes through the shade 1 and the image carried by the shade, then through the lens 2 and into the ambient area which is illuminated by the troffer 3. This produces a lighting effect.

There are several other standard size fluorescent fixtures in use. Embodiments of the fluorescent shade may be sized for availability to fit the most common of these sizes (e.g. a two-bulb narrow version of the troffer 3 of FIG. 5).

Custom sized implementations may involve trimming the desired size of the light shade from a larger section, or roll of material. This technique may be used to provide custom lighting to residential users who have custom fluorescent lighting solutions installed in their homes. A typical installation would be a kitchen, or bathroom fixture.

While the majority of lighting currently targeted by the method of diffusion is of the fluorescent type, future developments in the lighting industry may produce alternate devices that meet the lighting requirements efficiently while maintaining a low operating temperature. Other lighting devices may include, for example, LED light sources. The basic artistic light diffusion qualities of the fluorescent shades will allow it to be readily adapted to these future applications.

Embodiments of the light shade may be produced on translucent backlit media using printing techniques. An end result may be a light shade that includes an image thereon, which may be a representation of various artistic designs.

Exemplary materials which may be used to produce the shade, while not limited to any single print medium, includes polyester sheets, HP Color Lucent Backlit UV film, and Kodak DURATRANS™ or ENDURA™ . In an exemplary embodiment a fluorescent shade preferably may have the capability to maintain image quality for several years, despite the constant attack of UV rays produced by fluorescent lights. Other embodiments may be more temporary, e.g. fluorescent shades produced for a given event or seasonal celebration.

In an exemplary embodiment, the shade simply lays on top of an existing lens in the lighting fixture. Installation may be achieved in one exemplary installation by simply opening the fixture, laying the shade with the artwork on the existing lens, and closing the fixture, as depicted in FIG. 1, for example.

In an exemplary embodiment for a ceiling fixture, no adhesive materials or techniques are used for implementation.

An alternate exemplary embodiment for a ceiling fixture may involve the use of a mild adhesive such as clear tape or silicon to tack down the corners of the shade during the installation phase such that it remains in place during the re-installation of the fluorescent lens. This embodiment may be particularly useful, for example, to assist assembly in fixtures without a flip-open mechanism.

The shade may be sized to accommodate the small variations in dimension of the various standard troffers.

In an exemplary embodiment, the light shade is not permanently fixed to a lighting fixture and can be removed and re-located, or placed in storage. This is especially desirable to companies and individuals that lease their space. FIG. 3 shows an exemplary embodiment of a fluorescent light shade rolled up into a cylindrical shape for transport or storage.

In a further embodiment, a method for illuminating a space, e.g. a room space, includes installing a shade structure with artwork formed thereon, as described above, in a light fixture, e.g. a fluorescent light fixture such that the shade is placed on a fixture lens between the lens and the light source, and illuminating the space with light emitted by the light source which passes through the fluorescent shade and the artwork, then through the fixture lens and into the space. This provides a lighting effect different from that produced by the light fixture in the absence of the shade. To convert the fixture back to the conventional usage, the shade may be removed from its position on the fixture lens.

The range of effects and themes possible using an exemplary method of light diffusion may be limited only by the artist and what he is capable of creating. Exemplary themes might include nature design types such as mountain scapes, sky or planetary scenes, underwater vistas, or alternately, geometric shapes, wrought iron simulations against various translucent textures, stained glass effects, or mosaics. The art design process may involve an effort to produce designs that offer higher light pass-through if desired, or perhaps brilliant, colorful designs that reduce light by a greater factor, while producing a stunning effect. Much like an industry such as wall coverings, interior paints, or clothing fabrics, the artwork addresses the breadth of artistic tastes and desires of the general population.

Businesses that routinely have clientele lying down facing the ceiling can create a more pleasant experience for their customers. Chiropractors, physical therapists, dentists, and doctors are examples of such businesses.

Health clubs that desire a more stimulating environment for their members can greatly enhance the generic lighting equipment in their facilities. These clubs present another example of clientele lying down while facing upward directly towards the ceiling lighting.

Computer programmers, or other office workers that can benefit from reduced screen glare, may greatly appreciate the reduction of ambient light within their workspaces. Enhanced computer screen contrast and clarity may be obtained with effective use of the fluorescent shade.

Businesses may employ the shade to promote products or services, when the image applied to the shade substrate includes an advertisement placement. Thus, the image may be decorative or informative, or both. Due to the ease of installation, the fluorescent provides a convenient method of advertising in this fashion.

Although the foregoing has been a description and illustration of specific embodiments of the subject matter, various modifications and changes thereto can be made by persons skilled in the art without departing from the scope and spirit of the subject matter as defined by the following claims.

What is claimed is:

1. A method for illuminating a space, comprising:
installing a shade structure in a light fixture, such that the shade structure is placed on a fixture lens between the lens and a light source of the light fixture, the shade structure comprising a thin translucent layer including an artwork pattern or image formed thereon or embedded therein; and
illuminating the space with light emitted by the light source which passes through the shade structure and the artwork, then through the fixture lens and into the space, producing a lighting effect different from that produced by the light fixture and fixture lens in the absence of the shade.

2. The method of claim 1, further comprising:
converting the light fixture back to a conventional usage by removing the shade structure from its position on the fixture lens.

3. The method of claim 2, wherein the thin translucent layer is fabricated of a flexible material, and further comprising:
rolling the shade structure into a rolled condition for transport or storage.

4. The method of claim 1, wherein said light fixture is a ceiling mounted fluorescent light fixture comprising a troffer housing and a hinged lid carrying the fixture lens, and said installing the shade structure comprises:
opening the hinged lid to access a space within the housing;
placing the shade structure onto a surface of the fixture lens; and
closing the hinged lid.

5. The method of claim 1, wherein said shade structure is a flexible layer of a translucent material on which the artwork pattern or image is formed.

6. The method of claim 1, wherein the shade structure is fabricated of a backlit medium.

7. A shade structure for a ceiling-mounted light fixture which includes a planar lens and a fluorescent light source, the shade structure sized and adapted to be placed on and supported by the fixture lens between the fixture lens and a light source of the light fixture, the shade structure comprising a thin translucent layer including an artwork pattern or image formed thereon or embedded therein, wherein said thin translucent layer is a separate structure from the planar lens of the light fixture.

8. The shade structure of claim 7, wherein the thin translucent layer is fabricated of a flexible material.

9. The shade structure of claim 7, wherein the shade structure is fabricated of a backlit medium.

10. The shade structure of claim 7, further comprising an adhesive to tack down the corners of the shade during an installation phase.

11. The shade structure of claim 7, wherein the shade structure is adapted to be non-permanently installed in a lighting fixture, such that it can be removed and re-located, or placed in storage.

12. The shade structure of claim 7, wherein said thin translucent layer is approximately 46 inches in length by 22 inches in width.

13. The shade structure of claim 7, wherein said artwork pattern or image is one of a mountain scape, sky or planetary scenes, underwater vistas, geometric shapes, wrought iron simulations, stained glass effect, and a mosaic pattern.

14. The shade structure of claim 7, wherein said thin translucent layer has a thickness of about 8 mils.

15. A shade structure for a ceiling-mounted light fixture which includes a lens and a fluorescent light source, the shade structure sized and adapted to be placed on and supported by the fixture lens between the fixture lens and a light source of the light fixture when in use, of a size generally conforming to the size of the lens, the shade structure adapted to be readily removed from the light fixture, the shade structure comprising a thin translucent layer of backlit media including an artwork pattern or image formed thereon or embedded therein, wherein said thin translucent layer is a separate structure from the planar lens of the light fixture, and wherein when in use, light emitted by the light source passes through the shade structure and the artwork, then through the fixture lens and into a room, producing a lighting effect different from that produced by the light fixture and fixture lens in the absence of the shade.

16. The shade structure of claim 15, wherein the thin translucent layer is fabricated of a flexible material.
